(19) United States
(12) Patent Application Publication
(10) Pub. No.: US 2007/0025781 A1
(43) Pub. Date: Feb. 1, 2007

(54) Fixing device and image formation apparatus

(75) Inventors: Jinju Okuno, Toyohashi-shi (JP); Koji Yamamoto, Toyokawa-shi (JP); Taizou Oonishi, Toyokawa-shi (JP); Osamu Morita, Hoi-gun (JP); Koji Takahashi, Toyokawa-shi (JP); Mamoru Fukaya, Nagoya-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/430,104

(22) Filed: May 9, 2006

(30) Foreign Application Priority Data
Jul. 26, 2005 (JP) 2005-215791
Jul. 26, 2005 (JP) 2005-215794

(51) Int. Cl. G03G 15/20

(52) U.S. Cl. 399/322

(57) ABSTRACT

This fixing device has a fixing portion coming into contact with one face of a sheet, a plurality of drive portions coming into contact with the other face of the sheet to nip the sheet with the fixing portion, and a control portion for driving a plurality of the drive portions. The drive portions are placed in a direction orthogonal to a transportation direction of the sheet. The control portion controls driving of the drive portions independently of each other so that a speed difference may be imparted to the transportation speed of the sheet in the direction orthogonal to the transportation direction of the sheet. Thereby, it becomes possible to stabilize passing posture of the sheet S, and therefore to decrease wrinkling and image failure attributed to the passing posture of the sheet.

### CROSS-REFERENCE TO RELATED APPLICATIONS

This application is based on application No. 2005-215791 and 2005-215794 filed in Japan, the entire contents of which are hereby incorporated by reference.

### BACKGROUND OF THE INVENTION

The present invention relates to a fixing device for use in electrophotographic image formation apparatuses such as copying machines, laser printers and facsimiles, and further relates to an image formation apparatus with use of the fixing device.

Conventionally, a fixing device, which is mounted on an electrophotographic color printer or a color copying machine, has a heating roller 102, a fixing roller 103, a fixing belt 101 wound around the heating roller 102 and the fixing roller 103, and a pressure roller 104 coming into contact with the fixing roller 103 through the fixing belt 101 to constitute a nip portion therewith, as shown in FIG. 17.

The heating roller 102 is heated by a halogen lamp 121 inside thereof. The halogen lamp 121 is controlled by a thermister 122 which detects temperature of the heating roller 102.

Then, the fixing belt 101 is heated by the heating roller 102. While a sheet S is nipped in the nip portion and transported, a toner t attached to the sheet S is melted to be fixed.

Another fixing device, as shown in FIG. 18, has a heating roller 102 and a pressure roller 104 which comes into contact with the heating roller 102 and constitutes a nip portion therewith.

The heating roller 102 is heated by a halogen lamp 121 inside thereof. The halogen lamp 121 is controlled by a thermister 122 which detects temperature of the heating roller 102.

Then, the heating roller 102 is heated. While a sheet S is nipped in the nip portion and transported, a toner t attached to the sheet S is melted and fixed.

In the case of the fixing devices shown in FIG. 17 and FIG. 18, however, due to heat capacity of the pressure roller 104 and the like, it takes about one minute to several minutes to heat the fixing belt 101 and the heating roller 102 to fixable temperatures after power is turned on.

Moreover, in order to satisfy user's request for printing in a short waiting time, it is necessary to maintain the fixing belt 101 and the heating roller 102 at high temperatures even during standby state in consideration of heat capacity of the pressure roller 104 and the like. As the result, electric power is highly consumed in the fixing devices as well.

To deal with this, there has been provided a fixing device having the improved temperature rise characteristics, where it takes a shorter time after turn-on to reach the fixable state, and at the same time, standby temperature of the fixing device is lowered to reduce power consumption (JP H06-301302 A).

As shown in FIG. 19, the fixing device has a vibration article 141 coming into contact with one surface of a sheet S on which images are recorded, a heater 140 for heating the sheet S through the vibration article 141, and a guide plate 142 for nipping the sheet S with the vibration article 141.

Then, while the sheet S is transported by vibration of the vibration article 141, the sheet S is heated by the heater 140 through the vibration article 141 so that a toner t attached to the sheet S is melted and fixed.

In the fixing device shown in FIG. 19, the heat capacity of the fixing device is derived only from the heater 140, the vibration article 141 and the guide plate 142. Therefore, the heat capacity of the fixing device is low, which makes it possible to enhance the temperature rise characteristics.

Herein, in the case of recording color images on the sheet S, for keeping images glossy, it is essential to press the recording face of the sheet S through an elastic layer.

However, when recording the color images with use of the fixing device shown in FIG. 19, a fixed elastic layer should be interposed in between the vibration article 141 and the sheet S. This prevents vibration of the vibration article 141 from being transmitted to the sheet S, which makes it impossible to transport the sheet S. Moreover, since heat is supplied through the vibration article 141, a warm-up time is prolonged by a time for warming the vibration article 141.

In the fixing devices shown in FIG. 17 and FIG. 18, the sheet S needs to maintain the state absolutely free from slack when the sheet S passes the nip portion. The presence of slack in the axial direction of the fixing belt 101 in FIG. 17 and the heating roller 102 in FIG. 18, even if the slack is small, causes the sheet S to be wrinkled when the sheet S passes the nip portion.

Accordingly, in order to lead the sheet S to the nip portion in the state that the sheet S is pulled in the axial direction, transportation speed given to the sheet S in the nip portion is differentiated in both end portions and a center portion of the fixing belt 101 and/or the heating roller 102.

More specific description will be given in the case of the fixing device shown in FIG. 17. As shown in FIG. 20, the external diameter of both the end portions of the heating roller 102 is larger (by about 0.1 mm) than the external diameter of the center portion of the heating roller 102. The transportation speed given to the sheet S in the nip portion is higher when distortion of the elastic layer of the heating roller 102 in the nip portion is larger. Therefore, both the end portions of the heating roller 102 having large external diameter can give the sheet S a higher transportation speed than the speed given by the center portion of the heating roller 102 having small external diameter.

In an image formation apparatus using the fixing device, transportation force given to the sheet S by the fixing device is considerably larger than transportation force given to the sheet S by other processes. Therefore, a problem of image displacement occurs if fluctuation in transportation force given to the sheet S by the fixing device is transmitted to devices located on the upstream side of a transfer device in the image formation apparatus.

Accordingly, in order to prevent fluctuation in transportation force of the fixing device from being transmitted to the devices located on the upstream side of the transfer device, slack called a loop is generally formed in the sheet S between the fixing device and the transfer device.

Also, as shown in FIG. 21, a sheet transportation device for blocking transmission of fluctuation in transportation force has been provided (see U.S. Pat. No. 5,548,388).

The sheet transportation device, which is placed between the fixing device and the transfer device, has suction belts 71, 71 on both ends of the sheet transportation device and suction belts 75, 75 in the center thereof. The device transports the sheet S by using these suction belts 71, 75 while sucking the sheet S onto the suction belts 71, 75 by vacuuming.

So as not to transmit fluctuation in transportation force caused by the fixing device, the feed speed of the suction belts 75, 75 in the center of the sheet transportation device is made lower than the feed speed of the suction belts 71, 71 on both ends thereof.

However, in the case where the external diameter of both the end portions of the heating roller 102 is larger than the external diameter of the center portion of the heating roller 102 as shown in FIG. 20, the nip portion has different width sizes and pressures in axial direction of the heating roller 102. This brings about a quality difference in fixation of the sheet S in the width direction.

Moreover, in the case where the slack called a loop is formed in the sheet S between the fixing device and the transfer device, no effective result can be obtained without a sufficient amount of the loop. More specifically, fluctuation in transportation posture of the sheet S leads to a difference in loop amount at both ends of the sheet S in the width direction thereof. When an amount of loop on the one side becomes extremely large, displacement of images occurs. Therefore, a satisfactory effect cannot be expected in small-size image formation apparatuses in particular.

Moreover, in the sheet transportation device shown in FIG. 21, a transportation route from the transfer device to the fixing device should be kept horizontal. Also, the size of the sheet transportation device itself lowers the degree of freedom in the structure of the image formation apparatus and hinders downsizing. Moreover, transportation force is given to the sheet S by friction generated by suction force of the suction belts 71, 75, and therefore, it is not possible to actively provide the sheet S with constraint force in comparison with the case of controlling the transportation posture of the sheet S by transportation speed difference.

### SUMMARY OF THE INVENTION

An object of the present invention is to provide a fixing device capable of enhancing image quality, implementing downsizing and reducing warm-up time.

In order to achieve the above-mentioned object, a first aspect of the present invention provides a fixing device comprising:

a fixing portion coming into contact with one face of a sheet on which an image is recorded and having an elastic layer so as to press the sheet through the elastic layer;

a heating portion for heating the sheet through the fixing portion;

a transportation portion coming into contact with other face of the sheet to nip the sheet with the fixing portion and having a vibration article so as to transport the sheet with vibration of the vibration article; and

a control portion for controlling vibration of the vibration article.

Herein, the fixing portion includes, specifically, a fixing roller, a fixing belt or a fixing sheet.

According to the fixing device in the present invention, the fixing portion presses one face (recording face) of the sheet through the elastic layer so that image quality with excellent gloss can be implemented. Moreover, transporting the sheet by vibration of the vibration article makes it possible to simplify the structure for transporting the sheet and to reduce heat capacity of the structure. Thereby the warm-up time of the fixing device can be shortened. Moreover, since the transportation portion contacts the other face (non-recording face) of the sheet, fading of images can be prevented.

A second aspect of the present invention provides an image formation apparatus, comprising:

an imaging portion for attaching a developer to a sheet to form an image;

a fixing portion coming into contact with one face of a sheet on which an image is recorded and having an elastic layer so as to press the sheet through the elastic layer;

a heating portion for heating the sheet through the fixing portion;

a transportation portion coming into contact with other face of the sheet to nip the sheet with the fixing portion and having a vibration article so as to transport the sheet with vibration of the vibration article; and

a control portion for controlling vibration of the vibration article.

The image formation apparatus in the present invention is provided with the fixing device, which makes it possible to enhance image quality, implement downsizing and reduce warm-up time of the fixing device.

A third aspect of the present invention provides a fixing device comprising:

a fixing portion coming into contact with one face of a sheet;

a transportation portion coming into contact with other face of the sheet to nip the sheet with the fixing portion and having a plurality of drive portions arrayed in a direction intersecting with a transportation direction of the sheet and driven independently of each other so as to transport the sheet by driving of the drive portions; and

a control portion for controlling driving of the drive portions independently of each other.

According to the fixing device of the present invention, the control portion controls the drive portions independently of each other so that the transportation speed of the sheet may be differently given in the direction intersecting with the transportation direction of the sheet.

Thus, it becomes possible to impart speed difference to the transportation speed of the sheet without imposing any influence on the width of a nip portion formed by the contact between the fixing portion and the transportation portion and the pressure of the nip portion. Therefore it becomes possible to control the posture of the sheet when the sheet passes the nip portion without having an influence on the fixing quality.

Moreover, since the speed difference is imparted by strong transportation force in the nip portion, the passing posture of the sheet can be actively controlled, which makes it possible to reduce the amount of loop required on the upstream side of the nip portion.

Therefore, the passing posture of the sheet can be stabilized with a small space, and therefore, which allows for a fixing device with less wrinkling and image failure attributed to the passing posture of the sheet.

A fourth aspect of the present invention provides an image formation apparatus comprising:

an imaging portion for attaching a developer to a sheet to form an image;

a fixing portion coming into contact with one face of a sheet;

a transportation portion coming into contact with other face of the sheet to nip the sheet with the fixing portion and having a plurality of drive portions arrayed in a direction intersecting with a transportation direction of the sheet and driven independently of each other so as to transport the sheet by driving of the drive portions; and

a control portion for controlling driving of the drive portions independently of each other.

The image formation apparatus of the present invention has the above-stated fixing device, so that it is possible to enhance image quality and implement downsizing.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a simplified structure view showing a fixing device in a first embodiment of the present invention;

FIG. 2 is a cross sectional view showing a fixing portion of the fixing device;

FIG. 3 is a simplified structure view showing a fixing device in a second embodiment of the present invention;

FIG. 4 is a simplified structure view showing a fixing device in a third embodiment of the present invention;

FIG. 5 is a simplified structure view showing a fixing device in a fourth embodiment of the present invention;

FIG. 6 is a simplified structure view showing a fixing device in a fifth embodiment of the present invention;

FIG. 7 is a simplified structure view showing another vibration article;

FIG. 8 is a simplified structure view showing still another vibration article;

FIG. 9 is a simplified structure view showing an image formation apparatus in the present invention;

FIG. 10 is a simplified structure view showing a fixing device in a ninth embodiment of the present invention;

FIG. 11 is a perspective view showing a fixing device of the present invention;

FIG. 12 is a simplified structure view showing a fixing device in a tenth embodiment of the present invention;

FIG. 13 is a flowchart for correcting bias in loop amount in both end portions of a sheet;

FIG. 14 is a flowchart for preventing wrinkling of a sheet;

FIG. 15 is a perspective view showing another transportation portion;

FIG. 16 is a perspective view showing still another transportation portion;

FIG. 17 is a simplified structure view showing a conventional fixing device;

FIG. 18 is a simplified structure view showing another conventional fixing device;

FIG. 19 is a simplified structure view showing still another conventional fixing device;

FIG. 20 is a simplified structure view showing yet another conventional fixing device; and

FIG. 21 is a perspective view showing a conventional sheet transportation device.

### DETAILED DESCRIPTION OF THE INVENTION

The Present invention will be described in detailed below based on embodiments thereof. First Embodiment

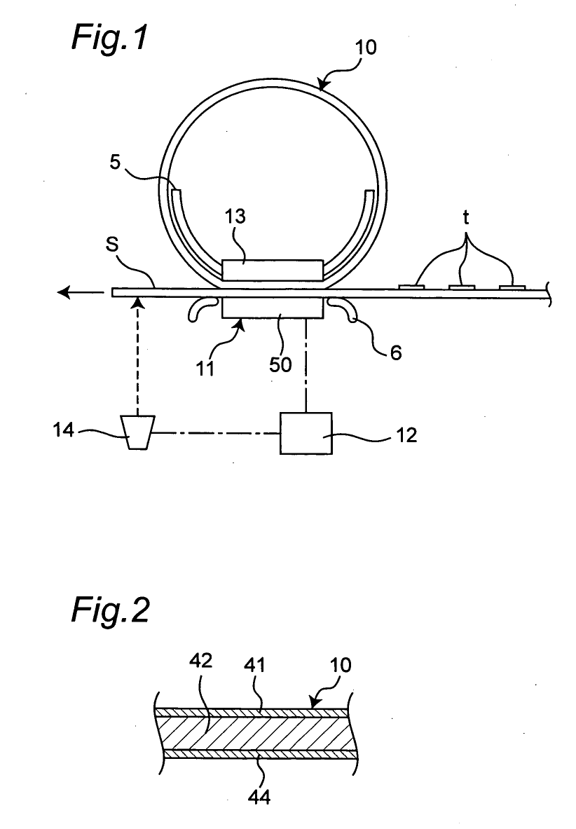

FIG. 1 is a simplified structure view showing a fixing device in a first embodiment of the present invention. The fixing device has a fixing portion 10 coming into contact with one face of a sheet S on which an image is recorded, a transportation portion 11 coming into contact with the other face of the sheet S to nip the sheet S with the fixing portion 10, a control portion 12 for controlling the transportation portion 11, and a heating portion 13 for heating the sheet S through the fixing portion 10.

The sheet S is, for example, a sheet such as a paper sheet and an OHP sheet. A toner t, which is attached to one face of the sheet S, is made of hot-melt materials such as resin, magnetic materials and colorants.

The fixing portion 10 is formed by a fixing belt where a base material layer 41, an elastic layer 42 and a release layer 44 are placed from within outward in the radial direction of the fixing portion 10, as shown in the cross sectional view in FIG. 2. The base material layer 41 is made of material having strength of aluminum or iron. The elastic layer 42 is made of material having heat resistance and elasticity of rubber or resin. The release layer 44 is made of material having release ability and heat resistance of silicon rubber, fluorocarbon rubber, PFA, PTFE, FEP and PFEP.

The transportation portion 11 has a vibration article 50, which comes into contact with the other face of the sheet S. Vibration of the vibration article 50 transports the sheet S.

The control portion 12 sends electric current to the vibration article 50 to vibrate the vibration article 50. The control portion 12 may vibrate the vibration article 50 with use of electric signals, pressure fluctuation, sound signals and mechanical vibration.

The control portion 12 controls vibration of the vibration article 50. Particularly, the control portion 12 controls the transportation speed of the sheet S by changing voltages or frequencies of a drive power source for driving the vibration article 50.

The heating portion 13 is, for example, a ceramic heater, which is placed inside the fixing portion 10. The heating portion 13 presses the fixing portion 10 to the side of the transportation portion 11 and retains it.

A guide plate 5 is placed inside the fixing portion 10, and supports the fixing portion 10 rotatably. Moreover, guide plates 6 are placed on the upstream side and the downstream side of the vibration article 50 in transportation direction of the sheet S for smooth transportation of the sheet S.

A speed detection portion 14 for detecting transportation speed of the sheet S is provided. The control portion 12 controls the transportation speed of the sheet S based on the speed detected by the speed detection portion 14.

The fixing portion 10, the heating portion 13 and the vibration article 50 have width sizes (sizes from the front to the back side of the sheet) larger than the width size of the sheet S.

Action of the fixing device is described next.

The sheet S is fed to a nip portion which is formed by the contact between the fixing portion 10 and the vibration article 50. The toner t is attached to one face of the sheet S in an unfixed state.

The fixing portion 10 is heated by the heating portion 13. One face of the sheet S is pressed and heated through the elastic layer 42 of the fixing portion 10 in the nip portion so as to melt and fix the unfixed toner t.

At the same time, transportation force is imparted to the other face of the sheet S by vibration of the vibration article 50, by which the sheet S is transported. In this case, the fixing portion 10 rotates in conjunction with transportation of the sheet S.

According to the thus-structured fixing device, the fixing portion 10 presses one face (recording face) of the sheet S through the elastic layer 42, so that image quality with excellent gloss can be implemented. Moreover, transporting the sheet S by vibration of the vibration article 50 makes it possible to simplify the structure to transport the sheet S and to reduce heat capacity. Thereby the warm-up time of the fixing device can be shortened. Moreover, fading of images can be prevented since the transportation portion 11 comes into contact with the other face (non-recording face) of the sheet S.

Thus, the fixing device is suitable for recording not only monochrome images but also color images. The fixing device enhances image quality, implements downsizing and reduces the warm-up time.

Moreover, the fixing portion 10 has the base material layer 41 inside the elastic layer 42, which allows integral formation of the base material layer 41 and the elastic layer 42, thereby making it possible to increase strength of the fixing portion 10.

Moreover, the heating portion 13 performs both retention of the fixing portion 10 and heating of the sheet S, which makes it possible to reduce the number of components, thereby allowing further downsizing.

Moreover, the control portion 12 controls the transportation speed of the sheet S, which allows fixing operation to be performed depending on the types of the sheet S.

Moreover, the control portion 12 controls the transportation speed of the sheet S based on the speed detected by the speed detection portion 14, which allows feedback control to be executed so as to transport the sheet S at an accurate speed.

Moreover, according to this fixing method, one face (recording-face) of the sheet S is pressed and heated through the elastic layer 42 of the fixing portion 10, so that image quality with excellent gloss can be implemented. Moreover, fading of images can be prevented since transportation force is imparted to the other face of the sheet S by vibration of the vibration article 50.

Second Embodiment

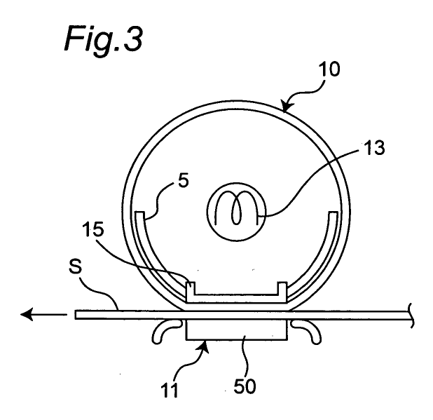

FIG. 3 shows a fixing device in a second embodiment of the present invention. The second embodiment is different from the first embodiment in the point that the fixing device separately has a retention portion 15 for pressing the fixing portion 10 to the side of the transportation portion 11 to retain the fixing portion 10 and a heating portion 13 for heating the fixing portion 10 through the fixing portion 10.

The retention portion 15 is placed inside the fixing portion 10 and sandwiches the fixing portion 10 with use of the transportation portion 11. The heating portion 13 is, for example, a halogen lamp.

Thus, the retention portion 15 and the heating portion 13 are provided independently, which allows the heating portion 13 to be placed freely.

Third Embodiment

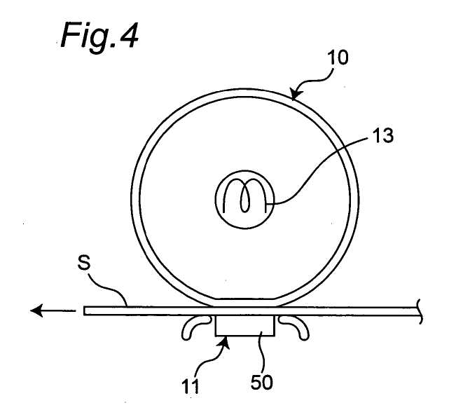

FIG. 4 shows a fixing device in a third embodiment of the present invention. The third embodiment is different from the first embodiment in the point that the fixing portion 10 is a fixing roller. The fixing roller, which is small in wall thickness, has, for example, a base material layer 41, an elastic layer 42 and a release layer 44 sequentially placed from the inside to the outside as shown in FIG. 2.

Thus, since the fixing portion 10 is formed from a fixing roller, the heating portion 13 and the retention portion 15 for pressing the fixing belt to the side of the transportation portion 11 to retain the belt are not necessary unlike the case where the fixing portion 10 is formed from a fixing belt. Moreover, the fixing roller can make driving torque smaller than that in the case of the fixing belt.

Fourth Embodiment

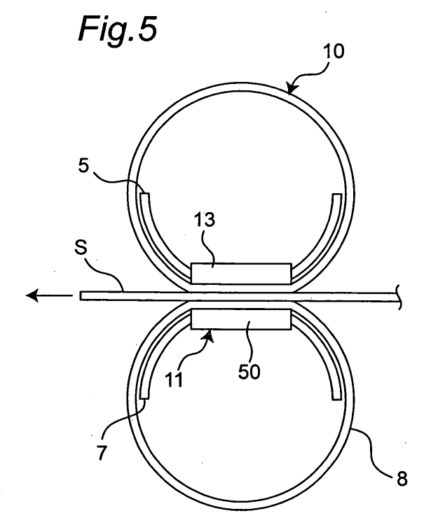

FIG. 5 shows a fixing device in a fourth embodiment of the present invention. The fourth embodiment is different from the first embodiment in the point that the transportation portion 11 has a belt 8 hung around the vibration article 50 and coming into contact with the other face of the sheet S.

A guide plate 7 is placed inside the belt 8, and the guide plate 7 supports the belt 8 rotatably. The belt 8 rotates and transports the sheet S with vibration of the vibration article 50.

Thus, since the transportation portion 11 has the belt 8, the sheet S is interposed in between the belt 8 and the fixing portion 10. Therefore, it becomes possible to easily lead the sheet S to a nip portion formed by the contact between the belt 8 and the fixing portion 10.

Moreover, it becomes possible to prevent the sheet S from coming into contact with corner portions of the vibration article 50 when the sheet S is lead to the nip portion. Therefore, a paper jam of the sheet S can be prevented. Moreover, the belt 8 rotates and transports the sheet S, which makes it possible to prevent friction with the sheet S.

Fifth Embodiment

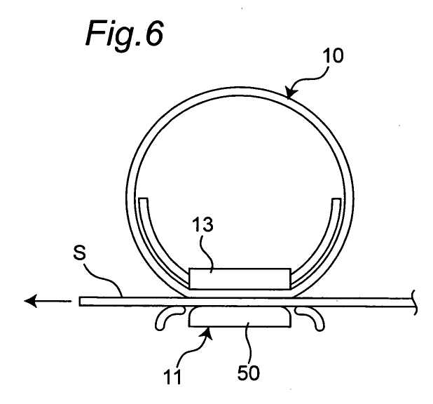

FIG. 6 shows a fixing device in a fifth embodiment of the present invention. The fifth embodiment is different from the first embodiment in the point that corner portions of the vibration article 50 are formed into an R shape on the upstream side and downstream side in the transportation direction of the sheet S.

Thus, the R-shaped corner portions of the vibration article 50 make it possible to easily lead the sheet S to the nip portion formed by the contact between the vibration article 50 and the fixing portion 10. Therefore, a paper jam of the sheet S can be prevented. Moreover, since the sheet S is directly transported by the vibration article 50, the transportation portion 11 can be further downsized and the heat capacity of the transportation portion 11 can be further reduced.

It is to be noted that the corner portions of the vibration article 50 may be formed into a tapered shape. In addition, at least an upstream corner portion of the vibration article 50 should be formed into an R shape or a tapered shape.

Six Embodiment

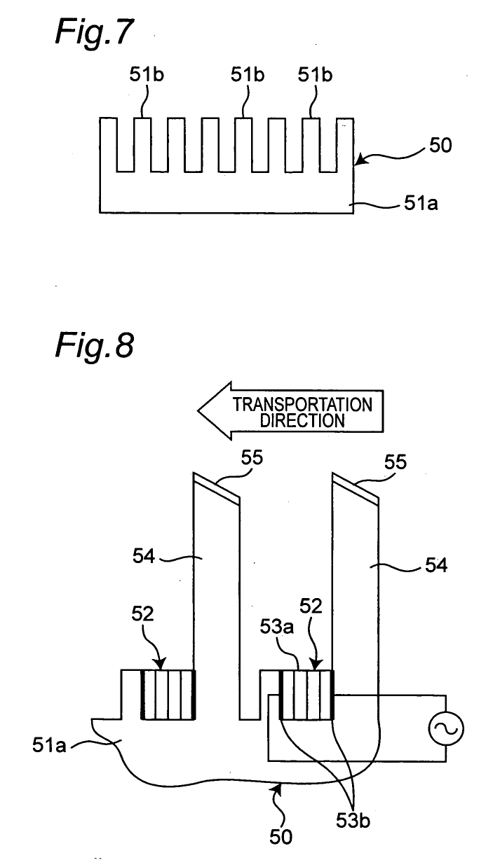

FIG. 7 shows a fixing device in a sixth embodiment of the present invention. The sixth embodiment is different from the first embodiment in the point that the vibration article 50 has a base portion 51a and a plurality of vibrators 51b mounted on the base portion 51a in transportation direction of the sheet S. The vibration article 50 has a comb-shaped cross section.

Thus, the vibration article 50 has a plurality of vibrators 51b, so that it is possible to make larger the nip portion formed by the contact between the vibration article 50 and the fixing portion 10. Thereby, the sheet S can be reliably fixed. Moreover, since the vibration article 50 has a plurality of divided vibrators 51b, it is easy to vibrate the vibrators 51b.

Seventh Embodiment

FIG. 8 shows a fixing device in a seventh embodiment of the present invention. The seventh embodiment is different from the first embodiment in the point that the vibration article 50 has a base portion 51a, a vibration amplification portion 54 whose one end is mounted on the base portion 51a, and an excitation portion 52 for vibrating one end of the vibration amplification portion 54.

A plurality of the vibration amplification portions 54 are placed in transportation direction (indicated by an arrow in FIG. 8) of the sheet S, and the vibration article 50 has a comb-shaped cross section. The excitation portion 52 has a laminated piezoelectric element 53a and electrodes 53b, 53b between which the piezoelectric element 53a is interposed.

The one end of each vibration amplification portions 54 is vibrated by applying voltage to the electrodes 53b, 53b, so that an amplitude of the excitation portion 52 is amplified. Thereby, the transportation speed of the sheet S is increased.

Moreover, the vibration amplification portion 54 is made of materials having low heat conductivity, which can prevent leakage of heat from the fixing portion 10 to the vibration article 50.

Moreover, the top end of the vibration article 50 is formed in such a way that a coefficient of friction in the transportation direction of the sheet S is larger than a coefficient of friction in the opposite transportation direction of the sheet S. Specifically, the top end of the vibration amplification portion 54 is inclined at an angle so that a distance to the sheet S is shorter toward the transportation direction of the sheet S.

In this way, at the top ends of the vibration article 50 (i.e. top ends of the vibration amplification portions 54), each swing of the top ends in the transportation direction effectively acts on the sheet S. When the top ends of the vibration article 50 swing in the opposite direction of the transportation direction, the transportation force caused by the vibration article 50 is decreased in the opposite direction. This makes it possible for the vibration article 50 to effectively transport the sheet S.

Moreover, the top end of the vibration article 50 (top end of the vibration amplification portion 54) has a release layer 55. This prevents the toner t, which is attached to the fixing portion 10, from being fixed onto the vibration article 50. Moreover, the release layer 55 has high slidability. Therefore, when the top end of the vibration article 50 swings to the opposite direction of the transportation direction, the transportation force to the opposite direction by the vibration article 50 may be decreased due to the high slidability.

Eighth Embodiment

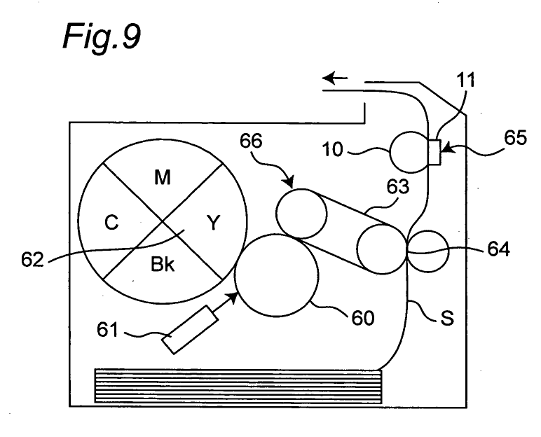

FIG. 9 is a simplified structure view showing an image formation apparatus in an eighth embodiment of the present invention. The image formation apparatus has an imaging device 66 and a fixing device 65 of the first embodiment. The imaging device 66 fixes an unfixed toner t onto a sheet S to form an image. The fixing device 65 melts the toner t and fixes it onto the sheet S. The image formation apparatus is an electrophotographic four-color printer.

The imaging device 66 has a photoreceptor 60, an (unshown) charging unit for applying specified charging processing to the photoreceptor 60, an exposure unit 61 for applying laser light to the photoreceptor 60, a four-color development unit 62 for developing images on the photoreceptor 60, an intermediate transfer belt 63 on which images formed on the photoreceptor 60 is transferred, and a secondary transfer portion 64 for transferring the images transferred to the intermediate transfer belt 63 to the sheet S.

The development unit 62 has cartridges containing Bk (Black), C (Cyan), M (Magenta), and Y (yellow) toners placed clockwise.

Description is now given of the action of the image formation apparatus.

A specified potential is formed on the surface of the photoreceptor 60 with the (unshown) charging unit. The surface of the photoreceptor 60 is irradiated with laser light by the exposure unit 61 in conformity to a desired image pattern to print. At this point, the potential in an irradiated portion on the surface of the photoreceptor 60 is attenuated, and an electrostatic image is formed on the surface of the photoreceptor 60.

The toner in the development unit 62 is in a pre-charged state. By electrostatic suction force between the toner and the surface of the photoreceptor 60, the toner is attached to the photoreceptor 60 in conformity to the electrostatic image on the surface of the photoreceptor 60.

The toner attached to the surface of the photoreceptor 60 is transferred onto the intermediate transfer belt 63 by an electric field formed between the photoreceptor 60 and the intermediate transfer belt 63. These steps are repeated for four colors so that an image composed of four color toners superposed on top of each other is formed on the intermediate transfer belt 63.

The toner image formed on the intermediate transfer belt 63 is transferred to the sheet S with the aid of an electric field and pressure in the secondary transfer portion 64, and is finally fixed onto the sheet S with heat and pressure in the fixing device 65.

The thus-structured image formation apparatus has the fixing device 65, which makes it possible to enhance image quality and to implement downsizing and reduction in warm-up time of the fixing device 65. The fixing device as defined in any one of the second to seventh embodiments may be used for the fixing device in the image formation apparatus.

It should be noted that the present invention is not limited to the embodiments disclosed. For example, the fixing portion 10 may be a fixing sheet. Moreover, the fixing portion 10 may be driven independently in conformity to the transportation of the sheet S. Moreover, the fixing portion 10 may be heated by electromagnetic induction with an induction heater.

Pressing force which brings the fixing portion 10 and the transportation portion 11 close to each other should be imparted to at least either the fixing portion 10 or the transportation portion 11. Moreover, the vibration article 50 may be an piezoelectric element, which simplifies the structure of the vibration article 50.

Also, the image formation apparatus may be any one of monochrome/color copying machine, printer, FAX machine and composite machine thereof.

Ninth Embodiment

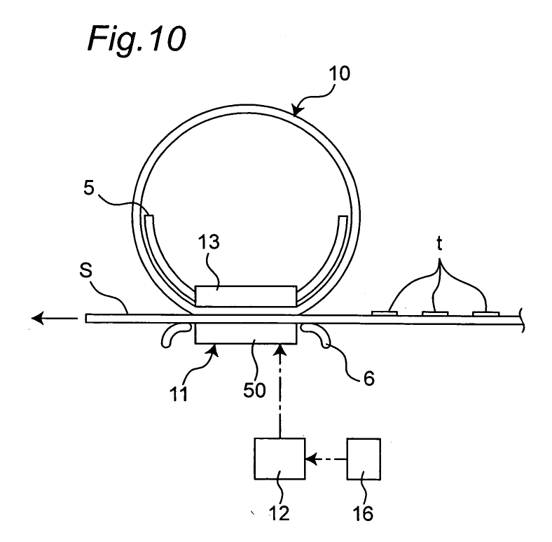

FIG. 10 shows a simplified structure view showing a fixing device in a ninth embodiment of the present invention. The basic structure of the fixing device shown in FIG. 10 is almost identical to that of the first embodiment shown in FIG. 1. Therefore, the description of identical parts is omitted. The setting portion 16 not shown in FIG. 1 but shown in FIG. 10 is described later.

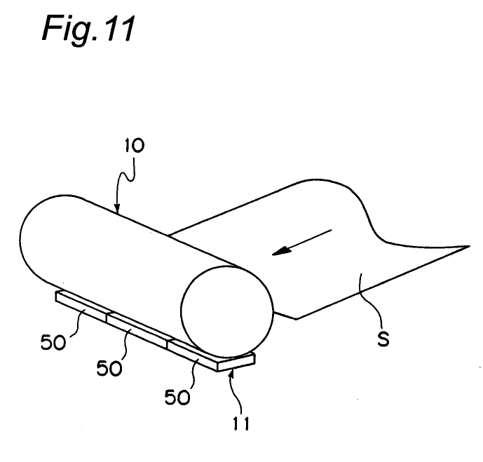

As shown in FIG. 11, the transportation portion 11 has a plurality of (three) drive portions 50 arrayed in direction intersecting with the transportation direction of the sheet S. A plurality of the drive portions 50 are arrayed in the direction orthogonal to the transportation direction of the sheet S (in axial direction of the fixing belt). A plurality of the drive portions 50 are driven independently of each other. The drive portions 50 come into contact with a lower face (other face) of the sheet S to transport the sheet S by driving of the drive portions 50. The drive portions 50 are vibration articles such as ultrasound transducers and piezoelectric elements or rollers.

The control portion 12 drives the drive portions 50 by applying a current to the drive portions 50. In the case that the drive portions 50 are vibration articles, the control portion 12 may vibrate the drive portions 50 with use of electric signals, pressure fluctuation, sound signals and mechanical vibration.

The control portion 12 controls driving of a plurality of the drive portions 50 independently of each other. More particularly, the control portion 12 changes voltages or frequencies of a drive power source for driving a plurality of the drive portions 50, so that transportation speed of the sheet S is controlled thereby.

The heating portion 13 is formed of, for example, a ceramic heater. The heating portion 13 is placed inside the fixing portion 10 as shown in FIG. 10. The heating portion 13 presses the fixing portion 10 to the side of the transportation portion 11 so as to retain the fixing portion 10.

A guide plate 5 is placed inside the fixing portion 10, and the guide plate 5 supports the fixing portion 10 rotatably. Moreover, guide plates 6 are placed on the upstream and downstream sides of the vibration article 50 in transportation direction of the sheet S so as to smoothly transport the sheet S.

The control portion 12 controls driving of a plurality of the drive portions 50 so that the transportation speed of a center portion of the sheet S is not larger than the transportation speed of both end portions of the sheet S in the width direction of the sheet S (in the direction orthogonal to the transportation direction of the sheet S). More particularly, as shown in FIG. 11, the transportation speed of the sheet S given by the end drive portions 50, 50 is larger than the transportation speed of the sheet S given by the central drive portion 50. For example, the transportation speed of both the end portions of the sheet S is set to be about 0.1 to 1% higher than the transportation speed of the central portion of the sheet S.

Thus, the transportation speed of both the end portions of the sheet S is set larger than the transportation speed of the center portion of the sheet S. Thereby, it becomes possible to lead the sheet S to the nip portion while pushing the sheet S in such a manner as to spread in a direction orthogonal to the transportation direction of the sheet S, which can prevent the sheet S from being wrinkled.

The fixing device has the setting portion 16 for setting a speed difference between the transportation speed of end portions of the sheet S in the width direction of the sheet S and the transportation speed of the center portion of the sheet S in the width direction of the sheet S. More specifically, the setting portion 16 receives inputs of set values of the speed difference from users and inputs the set values into the control portion 12. The setting portion 16 is constituted of, for example, an operation panel of an image formation apparatus including the fixing device and the like.

Thus, users can set a speed difference between both the end portions and the center portion of the sheet S with the setting portion 16. This makes it possible to change the difference in transportation speed of both the end portions and the center portion of the sheet S in conformity to the types of the sheets S (materials, thicknesses, etc.), and therefore to increase its application range.

The fixing portion 10, the heating portion 13 and a plurality of the drive portions 50 have width sizes (sizes in the direction from front to back side of the sheet paper in which FIG. 10 is shown) larger than the width size of the sheet S.

The action of the fixing device is now described.

The sheet S is fed to a nip portion formed by the contact between the fixing portion 10 and the vibration article 50. The toner t is attached to one face of the sheet S in an unfixed state.

The fixing portion 10 is heated by the heating portion 13, and one face of the sheet S is pressed and heated in the nip portion so as to melt and fix the unfixed toner t.

At the same time, transportation force is imparted to the other face of the sheet S by driving a plurality of the drive portions 50, by which the sheet S is transported. The fixing portion 10 rotates in conjunction with transportation of the sheet S.

In this case, a plurality of the drive portions 50 are driven independently of each other so that the transportation speed of both the end portions of the sheet S is larger than the transportation speed of the center portion of the sheet S. Thereby, the sheet S is pressed so as to spread in the direction orthogonal to the transportation direction of the sheet S.

According to the thus-structured fixing device, the control portion 12 controls driving of a plurality of the drive portions 50 independently of each other, which makes it possible to impart speed difference to the transportation speed of the sheet S in direction orthogonal to the transportation direction of the sheet S.

Thus, it becomes possible to impart speed difference to the transportation speed of the sheet without imposing influence on the width size and the pressure of the nip portion formed, and therefore it becomes possible to control the posture of the sheet when the sheet passes the nip portion without imposing influence on the fixing quality.

Moreover, the passing posture of the sheet S can be actively controlled since the speed difference is imparted by strong transportation force in the nip portion. Thus, it is possible to reduce the loop amount necessary for the upstream side of the nip portion.

Therefore, the passing posture of the sheet S can be stabilized in a small space, which makes it possible to provide a fixing device that has less wrinkling and image failure attributed to the passing posture of the sheet S.

Moreover, according to this fixing way, a plurality of the drive portions 50 are driven independently of each other to transport the sheet S, which makes it possible to impart speed difference to the transportation speed of the sheet S in the direction orthogonal to the transportation direction of the sheet S. Thus, the passing posture of the sheet S can be stabilized, so that wrinkling and image failure attributed to the passing posture of the sheet S can be reduced. Moreover, since transportation force is imparted to the other face of the sheet S by driving of the drive portions 50, it becomes possible to prevent images from fading.

Tenth Embodiment

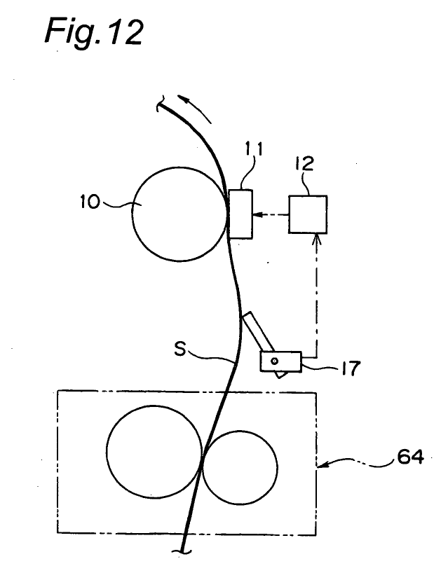

FIG. 12 shows a fixing device in a tenth embodiment of the present invention. The tenth embodiment is different from the ninth embodiment in the point that the fixing device has a detection potion 17 for detecting the posture of the sheet S placed upstream to the fixing portion 10 and the transportation portion 11.

The detection potion 17 is placed between the fixing portion 10 and a (later-described) secondary transfer portion 64. Three detection potions 17 are provided in the direction orthogonal to the transportation direction of the sheet S, and each detection potion 17 detects a slack amount (loop amount) formed in the sheet S during transportation. It is to be noted that the detection potion 17 may have any structure as long as the structure can detect a difference in loop amount of the sheet S in the width direction of the sheet S. For example, the detection potion 17 may be a plurality of range sensors integrally aligned, or it may be a contact sensor or a non-contact sensor.

In the present embodiment, the control portion 12 controls driving of each drive portion 50 based on outputs of the detection potion 17, which allows further stabilization of the passing posture of the sheet S in the nip portion, and allows prevention of wrinkling and image failure.

Correction control for correcting the passing posture of the sheet S is herein described so as to prevent an one-side loop amount of the sheet S from excessively increasing.

The detection potions 17 respectively detect slack amounts of both end portions of the sheet S in the width direction. The control portion 12 controls driving of each driving apportion 50 so that the slack amounts of both end portions in the width direction of the sheet S detected by the detection potions 17 become identical.

More specifically, both the end portions A and B of the sheet S are detected respectively by a detection portion 17A and a detection portion 17B when detection potions 17 placed at positions corresponding to both the end portions A and B of the sheet S are referred to as the detection portions 17A and 17B.

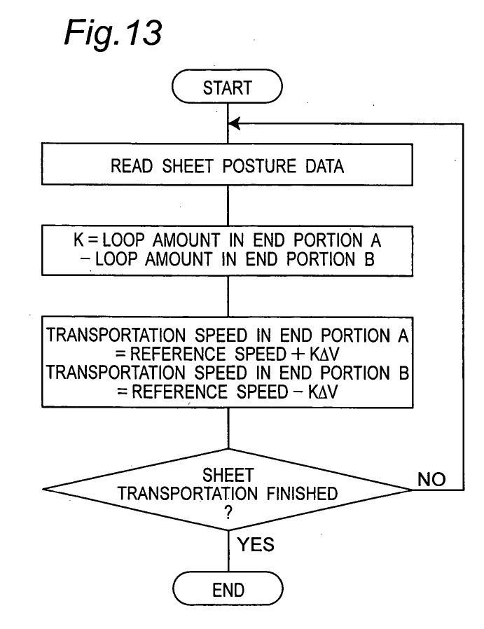

Then, execution of control is started in the state that the sheet S has entered the nip portion. As shown in FIG. 13, there is obtained a difference K between the loop amount in the end portion A detected by the detection portion 17A and the loop amount in the end portion B detected by the detection portion 17B.

Herein, the speed higher than reference transportation speed decreases the loop amount. In contrast, the speed lower than the reference transportation speed increases the loop amount. Accordingly, in the case where a loop amount on the side of the end portion A is large, the speed on the side of the end portion A is made larger by KΔV than the reference speed in proportion to a difference K in loop amount, while the speed on the side of the end portion B is made lower by KΔV than the reference speed.

The above-stated steps are repeated till the transportation of the sheet S is finished, so that the passing posture of the sheet S may be controlled regardless of the loop amount of both end portions of the sheet S.

Thus, since the control portion 12 controls driving of each drive portion 50 so that the slack amounts of both the end portions of the sheet S become identical, the sheet S can be fixed without bias in slack amount of both the end portions of the sheet S, which allows prevention of image displacement.

Correction control for correcting the passing posture of the sheet S is now described so as to prevent the sheet S from wrinkling.

Description of wrinkling of the sheet S is firstly given. When the sheet S enters the nip portion in the state that the center portion of the sheet S is slack, the sheet S is wrinkled by pressing the slack of the sheet S in the nip portion. The slack of the sheet S may be detected by a difference in slack amount (loop amount) between the center portion and both the end portions of the sheet S. It can be determined that the sheet S is wrinkled when the slack amount of the center portion is extremely smaller than the slack amount of both the end portions.

The detection potion 17 detects both the slack amount of both the end portions in the width direction of the sheet S and the slack amount in the center potion in the width direction of the sheet S. The control portion 12 controls driving of each drive portion 50 so that the slack amount of both the end portions in the width direction of the sheet S and the slack amount of the center potion in the width direction of the sheet S detected by the detection potion 17 become almost identical.

More specifically, both end portions A, B and a center C of the sheet S are detected respectively by the detection portions 17A, 17B and 17C when that three detection potions 17 are referred to as a detection portions 17A, 17B and 17C.

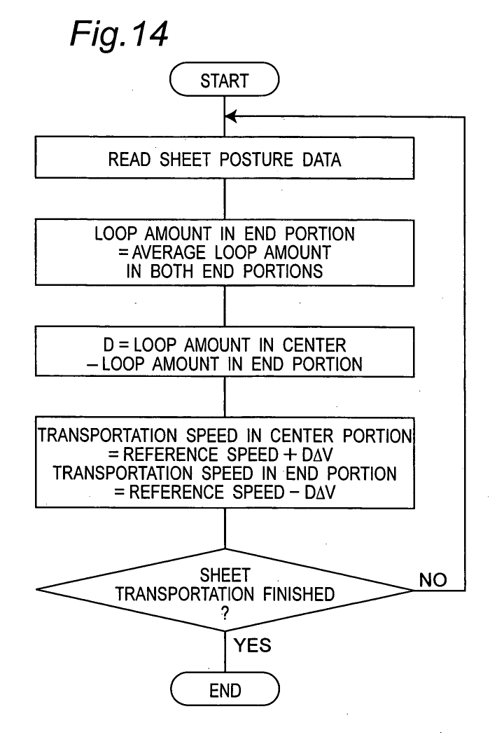

Then, execution of control is started in the state that the sheet S has entered the nip portion. As shown in FIG. 14, there is obtained a mean value of the loop amount in the end portion A detected by the detection portion 17A and the loop amount in the end portion B detected by the detection portion 17B. Then, there is obtained a difference D between the above-stated mean value of both the end portions and the loop amount in the center C detected by the detection portion 17C.

Then, when the loop amount in the center C is small, the speed in the center C is made lower by DΔV than the reference speed in proportion to the difference D in loop amount, while the speed of both the end portions A, B is made higher by DΔV than the reference speed.

These steps are repeated till the transportation of the sheet S is finished, so that the passing posture of the sheet S may be controlled so as to prevent the center of the sheet S from gaining extrusions or indentions.

Thus, the control portion 12 controls driving of each drive portion 50 so that the slack amount of both the end portions of the sheet S becomes almost identical to the slack amount of the center portion of the sheet S. Thereby, the passing posture of the sheet S can be controlled so as to prevent the center of the sheet S from gaining extrusions or indentions, which makes it possible to prevent the sheet S from wrinkling.

Eleventh embodiment

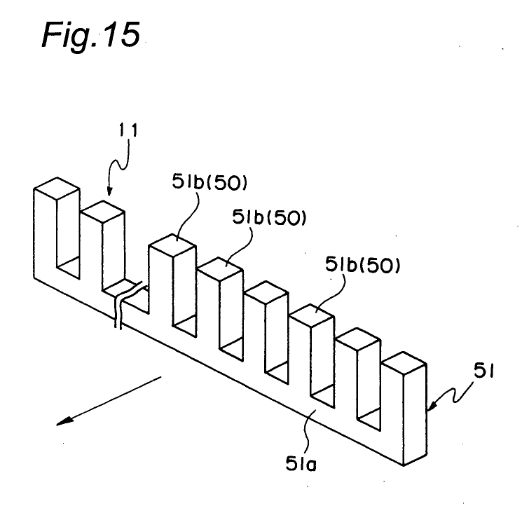

FIG. 15 shows a fixing device in an eleventh embodiment of the present invention. The eleventh embodiment is different from the ninth embodiment in the structure of the transportation portion.

The transportation portion 11 in the eleventh embodiment has a vibration article 51. The vibration article 51 has a base portion 51a and a plurality of vibrators 51b mounted on the base portion 51a in the direction (i.e. the axial direction of the fixing portion 10) orthogonal to the transportation direction (indicated by an arrow in FIG. 15) of the sheet S. The vibration article 51 has a comb-shaped cross section.

The sheet S is transported by vibration of a plurality of vibrators 51b. The vibrators 51b vibrate independently of each other. More particularly, the vibrators 51b correspond to the drive portions 50.

Speeds imparted to the vibrators 51b are obtained by the following equation (1) based on the reference speed difference (for example, KΔV, DΔV used in FIG. 13 and FIG. 14).
V=Vs×X/L (1)

wherein V denotes a speed difference imparted to each vibrator,

Vs denotes a reference speed difference,

X denotes a position of a vibrator (distance from the center between the vibrators in both ends), and

L denotes a half the length between the vibrators in both ends.

Thus, since a number of minute vibrators 51b (drive portions 50) are arrayed in comb shape, a speed difference between adjacent vibrators 51b, 51b becomes small. This allows smooth control on the passing posture of the sheet S, and makes it possible to obtain sufficient images from the sheets S.

Twelfth Embodiment

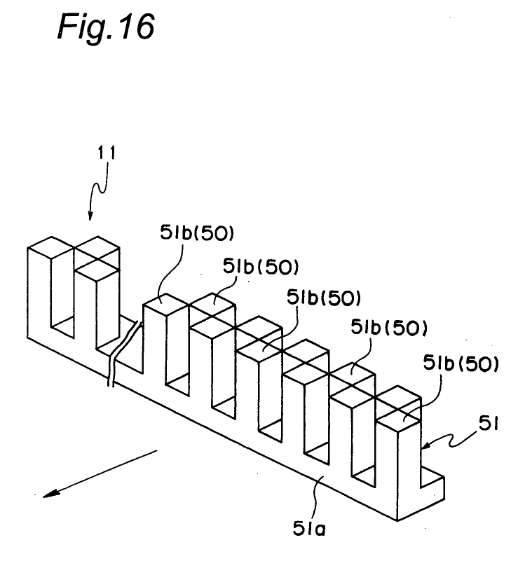

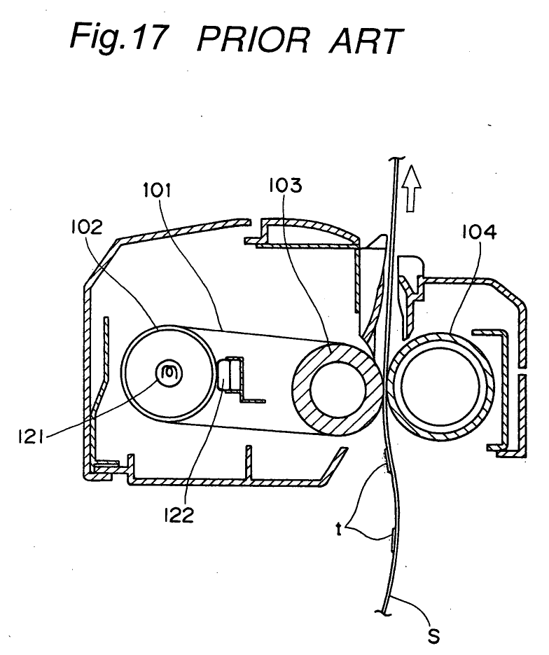

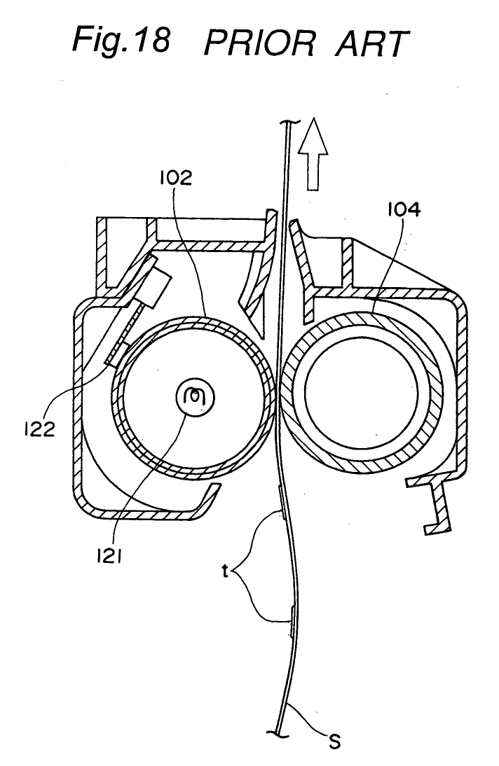

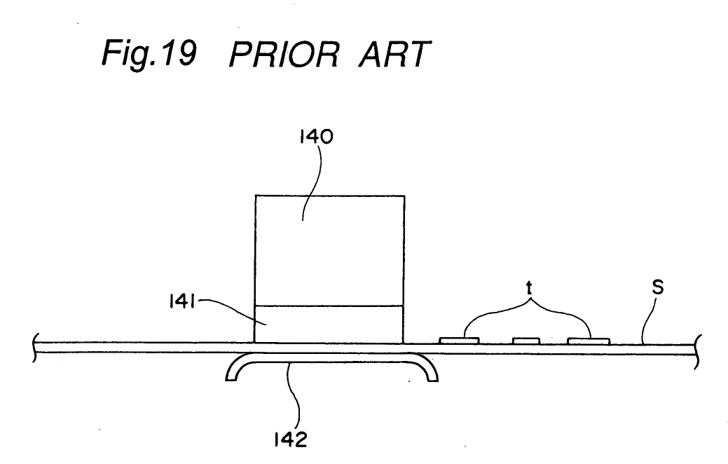

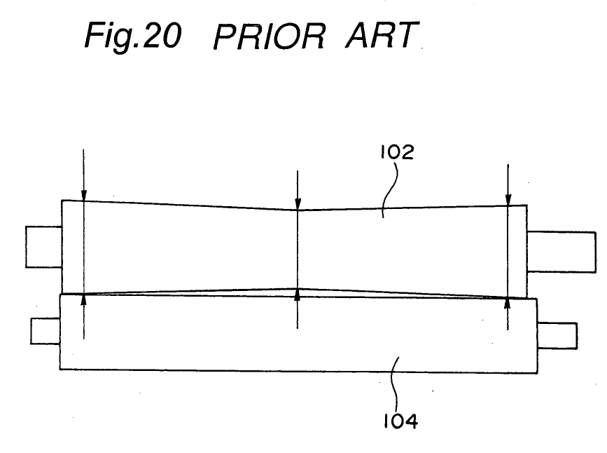

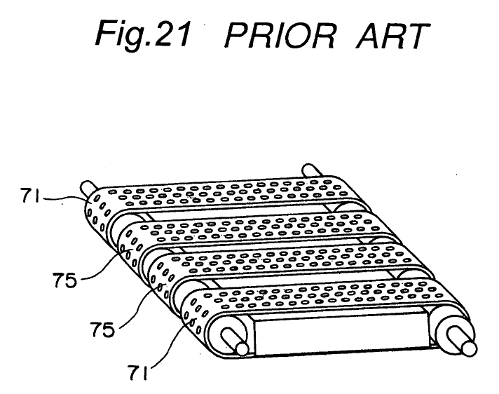

FIG. 16 shows a fixing device in a twelfth embodiment of the present invention. The twelfth embodiment is different from the eleventh embodiment in the point that a plurality of the vibrators 51b are placed in a zigzag manner in the direction orthogonal to the transportation direction (indicated by an arrow in FIG. 16) of the sheet S so that space between adjacent vibrators 51b, 51b is small.

Thus, since space between adjacent vibrators 51b, 51b is small, sufficient pressing force may be imparted to the sheet S, which makes it possible to prevent irregular gloss or irregular fixation strength.

Thirteenth Embodiment

The basic structure of an image formation apparatus in a thirteenth embodiment is identical to that shown in FIG. 9 of the eighth embodiment. Therefore, the description thereof is omitted here.

In the image formation apparatus shown in FIG. 9, a detection potion 17 for detecting the posture of the sheet S may be provided between the imaging device 66 (the secondary transfer portion 64) and the fixing device 65, as shown in FIG. 12 of the tenth embodiment.

In this case, the control portion 12 controls driving of each drive portion 50 based on outputs of the detection potion 17, which makes it possible to prevent fluctuation of the transportation force of the fixing device 65 from being transmitted to the processes upstream from the imaging device 66. Thereby, image displacement is prevented. The fixing device as stated in the eleventh embodiment or the twelfth embodiment may be used as a fixing device of the image formation apparatus of this embodiment.

It should be noted that the present invention is not limited to the embodiments disclosed. For example, the fixing portion 10 may be a fixing roller or a fixing sheet. The fixing sheet is structured such that both ends of a sheet body are respectively hung around rollers, and one roller takes up one end of the sheet body.

As in the case of the eighth embodiment, the fixing portion 10 may be driven independently in conformity to the transportation of the sheet S. Also, the fixing portion 10 may be heated by electromagnetic induction with an induction heater.

Further, pressing force which brings the fixing portion 10 and the transportation portion 11 close to each other should be imparted to at least either the fixing portion 10 or the transportation portion 11.

Furthermore, the image formation apparatus may be any one of monochrome/color copying machine, printer, FAX machine and composite machine thereof.

The drive portions 50 (the vibrators 51b) may be aligned in a direction inclined to the transportation direction of the sheet S, or arrayed in a zigzag manner in direction inclined to the transportation direction of the sheet S, as long as they are arrayed in direction intersecting with the transportation direction of the sheet S.

Also, “the posture of the sheet S” detected by the detection potion 17 may be the inclination of the sheet S from the transportation direction of the sheet S.

The number of the drive portions 50 is not particularly specified as long as the transportation speeds at least in the center and in both the ends of the sheet S may be controlled dependently. Moreover, a pressing portion for pressing the sheet S may be placed between the adjacent drive portions 50, 50.

The invention being thus described, it will be obvious that the invention may be varied in many ways. Such variations are not be regarded as a departure from the spirit and scope of the invention, and all such modifications as would be obvious to one skilled in the art are intended to be included within the scope of the following claims.

1. A fixing device comprising:
a fixing portion coming into contact with one face of a sheet on which an image is recorded and having an elastic layer so as to press the sheet through the elastic layer;
a heating portion for heating the sheet through the fixing portion;
a transportation portion coming into contact with other face of the sheet to nip the sheet with the fixing portion and having a vibration article so as to transport the sheet with vibration of the vibration article; and
a control portion for controlling vibration of the vibration article.

2. The fixing device as defined in claim 1, wherein
the fixing portion has a base material layer inside the elastic layer.

3. The fixing device as defined in claim 1, wherein
the heating portion presses the fixing portion to a side of the transportation portion so as to retain the fixing portion.

4. The fixing device as defined in claim 1, further comprising:
a retention portion for pressing the fixing portion to a side of the transportation portion so as to retain the fixing portion.

5. The fixing device as defined in claim 1, wherein
the transportation portion has a belt hung around the vibration article and coming into contact with the other face of the sheet, and
the belt rotates and transports the sheet with vibration of the vibration article.

6. The fixing device as defined in claim 1, wherein
the vibration article comes into contact with the other face of the sheet, and
a corner portion of the vibration article on an upstream side of a transportation direction of the sheet is formed into an R shape or a tapered shape.

7. The fixing device as defined in claim 1, wherein
the vibration article has a base portion and a plurality of vibrators mounted on the base portion in a transportation direction of the sheet.

8. The fixing device as defined in claim 1, wherein
the vibration article is a piezoelectric element.

9. The fixing device as defined in claim 1, wherein
the vibration article is a laminated piezoelectric element.

10. The fixing device as defined in claim 1, wherein
the vibration article has a base portion, a vibration amplification portion whose one end is mounted on the base portion, and an excitation portion for vibrating the one end of the vibration amplification portion.

11. The fixing device as defined in claim 1, wherein
a top end of the vibration article on a side of the fixing portion is formed so that a coefficient of friction on a side of a transportation direction of the sheet is larger than a coefficient of friction on an opposite side of the transportation direction of the sheet.

12. The fixing device as defined in claim 1, wherein
a top end of the vibration article on a side of the fixing portion has a release layer.

13. The fixing device as defined in claim 1, wherein
the control portion changes voltages or frequencies of a drive power source for driving the vibration article so as to control transportation speed of the sheet.

14. The fixing device as defined in claim 13, further comprising a speed detection portion for detecting the transportation speed of the sheet, wherein
the control portion controls the transportation speed of the sheet based on the speed detected by the speed detection portion.

15. An image formation apparatus, comprising:
an imaging portion for attaching a developer to a sheet to form an image;
a fixing portion coming into contact with one face of a sheet on which an image is recorded and having an elastic layer so as to press the sheet through the elastic layer;
a heating portion for heating the sheet through the fixing portion;
a transportation portion coming into contact with other face of the sheet to nip the sheet with the fixing portion and having a vibration article so as to transport the sheet with vibration of the vibration article; and
a control portion for controlling vibration of the vibration article.

16. A fixing device comprising:
a fixing portion coming into contact with one face of a sheet;
a transportation portion coming into contact with other face of the sheet to nip the sheet with the fixing portion and having a plurality of drive portions arrayed in a direction intersecting with a transportation direction of the sheet and driven independently of each other so as to transport the sheet by driving of the drive portions; and
a control portion for controlling driving of the drive portions independently of each other.

17. The fixing device as defined in claim 16, wherein
the control portion controls driving of a plurality of drive portions so that transportation speed of both end portions of the sheet located in a direction orthogonal to the transportation direction of the sheet is higher than transportation speed of a center portion of the sheet located in the direction orthogonal to the transportation direction of the sheet.

18. The fixing device as defined in claim 17, further comprising
a setting portion for setting a speed difference between the transportation speed of both the end portions of the sheet and the transportation speed of the center portion of the sheet.

19. The fixing device as defined in claim 16, further comprising a detection portion for detecting posture of the sheet located on an upstream side of both the fixing portion and the transportation portion in the sheet transportation direction, wherein
the control portion controls driving of a plurality of drive portions based on an output of the detection portion.

20. The fixing device as defined in claim 19, wherein
the detection portion detects respective slack amounts of both end portions of the sheet located in a direction orthogonal to the transportation direction of the sheet, and
the control portion controls driving of a plurality of drive portions so that the slack amounts of both the end portions of the sheet located in the direction orthogonal to the transportation direction of the sheet detected by the detection portion become identical.

21. The fixing device as defined in claim 19, wherein
the detection portion detects respective slack amounts of both end portions of the sheet located in a direction orthogonal to the transportation direction of the sheet and a slack amount of a center portion of the sheet located in the direction orthogonal to the transportation direction of the sheet, and
the control portion controls driving of a plurality of drive portions so that the slack amounts of both the end portions of the sheet and the slack amount of the center portion of the sheet detected by the detection portion become almost identical.

22. The fixing device as defined in claim 16, wherein
the fixing portion comes into contact with a face of the sheet on which an image is recorded.

23. The fixing device as defined in claim 16, further comprising
a heating portion for heating the sheet through the fixing portion.

24. An image formation apparatus comprising:
an imaging portion for attaching a developer to a sheet to form an image;
a fixing portion coming into contact with one face of a sheet;
a transportation portion coming into contact with other face of the sheet to nip the sheet with the fixing portion and having a plurality of drive portions arrayed in a direction intersecting with a transportation direction of the sheet and driven independently of each other so as to transport the sheet by driving of the drive portions; and
a control portion for controlling driving of the drive portions independently of each other.

25. The image formation apparatus as defined in claim 24, further comprising
a detection portion for detecting posture of the sheet located between the imaging portion and the fixing portion, wherein
the control portion controls driving of the drive portions based on an output of the detection portion.
